(19) United States
(12) Patent Application Publication
(10) Pub. No.: US 2019/0005252 A1
(43) Pub. Date: Jan. 3, 2019

(54) DEVICE FOR SELF-DEFENSE SECURITY BASED ON SYSTEM ENVIRONMENT AND USER BEHAVIOR ANALYSIS, AND OPERATING METHOD THEREFOR

(71) Applicant: NOD BIZWARE CO., LTD., Seoul (KR)

(72) Inventor: Seokgu YUN, Seoul (KR)

(21) Appl. No.: 16/063,265

(22) PCT Filed: Jan. 6, 2017
(86) PCT No.: PCT/KR2017/000204

§ 371 Date: Jun. 16, 2018

(30) Foreign Application Priority Data
Jan. 29, 2016 (KR) 10-2016-0011807

(51) Int. Cl. G06F 21/60; G06F 21/62; H04L 29/06

(52) U.S. Cl. CPC G06F 21/604; G06F 21/6227; H04L 63/1441; H04L 63/1425; H04L 63/20

(57) ABSTRACT

The present inventive concepts relate to an operating method of a database security apparatus which performs an analysis on a command requested by a user on the basis of a situation of a system and a pattern of the user. The operating method includes receiving a command related to a database managed in a database system from a client, confirming whether a service state of the database system is in a development state or an actual service state, changing a security policy for the database system in accordance with a result of the confirmation, determining whether the command transmitted from the client satisfies the changed security policy, and requesting an administrator client to confirm whether to execute the command in accordance with a result of the determination.

### CROSS-REFERENCE TO RELATED APPLICATION

This application is a U.S. national phase application of PCT International Application PCT/KR2017/000204, filed Jan. 6, 2007, which claims priority to Korean Patent Application No. 10-2016-0011807, filed Jan. 29, 2016, the contents of which are incorporated herein by reference in their entirety.

### TECHNICAL FIELD

Embodiments of the present inventive concept relate to a database security device and an operation method thereof, and more particularly, to a database security device for performing pre-analysis on commands requested by a user on the basis of a system situation and a pattern of the user to enhance security and an operating method thereof.

### BACKGROUND ART

As a degree of integration of information becomes more advanced, an amount of information accumulated in a database existing in an enterprise increases in proportion. Accordingly, there are frequent security incidents in which data stored in a database is lost, changed, or leaked to the outside due to various types of hacking or carelessness of users.

In particular, actual recent security incidents happened lately, for example, a case in which a bank operation is interrupted due to disappearance of all user transaction information for a certain period of time by a data deleting command requested by an administrator by mistake being executed, and a case in which funds of hundreds of millions of dollars have been taken out from an account by an unusual account transfer command of a user being executed several times in the middle of night, are looked into, it can be seen that most of such security incidents are caused by commands requested by users or administrators being executed as they are without any analysis.

Therefore, there is a need to urgently provide a security technology capable of performing various analyses on the commands requested by users or administrators before an execution and appropriately responding according to a result of the analyses.

### Technical Problem

An object of the present inventive concept is to provide a database security device which enhances security by performing pre-analysis on commands requested by a user or an administrator on the basis of a system situation and a pattern of the user

### Technical Solution

According to an exemplary embodiment of the present inventive concepts, an operating method of a security apparatus includes receiving a command related to a database managed in a database system from a client, confirming a service state of the database system, changing a security policy for the database system according to a result of the confirmation, determining whether the command transmitted from the client satisfies the changed security policy; and transmitting a request for confirming whether to execute the command to an administrator client according to a result of the determination.

The service state may be classified into at least two states in accordance with a set condition, and different security policies may be applied in respective states. Whether in the actual service state may be confirmed with reference to a state flag indicating the service state of the database system.

Whether in the actual service state may be confirmed on the basis of at least one of cumulative data information stored in the database, log information on the database, and a request state for the database system.

The security policy may be changed such that the client cannot use some commands among commands related to the database.

In the operating method of a security apparatus, when the command requests deletion, change, or inquiry of data exceeding a reference data amount, it is determined that the command does not satisfy the changed security policy.

The operating method of a security apparatus may further includes monitoring a connection and an access of the client to the database system, generating and storing a log of information acquired through the monitoring, analyzing a behavior pattern of the client on the basis of the log, and determining whether the command transmitted from the client matches the behavior pattern of the client.

The log may include at least one of connection IP information, user ID information, terminal information, application information, time information, query information, and command information.

The operating method of a security apparatus may further include forcibly terminating the connection of the client when the command does not match the behavior pattern of the client.

According to another exemplary embodiment of the present inventive concepts, a data security apparatus includes a communication module for receiving commands related to a database managed in a database system from a client, a service state analysis module for confirming a service state of the database system, a security policy management module for changing a security policy for the database system according to a result of the confirmation, a control module for determining whether the command transmitted from the client satisfies the change security policy, and an administrator notification module for transmitting a confirmation request for confirming whether to execute the command to an administrator client according to a result of the determination.

The database security apparatus according to claim 10 may further include a log generation module for monitoring a connection and an access of the client to the database system, generating and storing a log of information acquired through the monitoring, and a behavior analysis module for analyzing a behavior pattern of the client on the basis of the log, in which the control module determines whether the command transmitted from the client matches the behavior pattern of the client.

### Advantageous Effects

A database security method according to exemplary embodiments of the present inventive concepts can provide optimized security in each state by changing and applying a security policy according to a service progress state of a database system.

In addition, a database security method according to exemplary embodiments of the present inventive concepts can fundamentally block an execution of abnormal commands made by hacking or the like and enhance further security by analyzing a command on the basis of the behavior pattern of a user.

### BRIEF DESCRIPTION OF DRAWINGS

FIG. 1 is a block diagram which shows a schematic configuration of a data security system according to exemplary embodiments of the present inventive concepts;

FIG. 2 is a block diagram which shows a specific configuration of a security server according to the exemplary embodiments of the present inventive concepts;

FIG. 3 is a flowchart which shows an operating method of a security server according to the exemplary embodiments of the present inventive concepts; and

FIG. 4 is a flowchart which shows the operating method of a security server according to the exemplary embodiments of the present inventive concepts;

### BEST MODE

A module in the present specification may refer to hardware capable of performing functions and operations in accordance with respective names described in the present specification, may refer to a computer program code capable of performing a specific function and operation, or may refer to an electronic recording medium, such as a processor, which is equipped with a computer program code capable of performing a specific function and operation. In other words, a module may refer to a functional and/or structural combination of hardware for executing a technical concept of the present inventive concepts and/or software for driving the hardware.

Hereinafter, exemplary embodiments of the present inventive concepts will be described in detail with reference to accompanying drawings in the present specification.

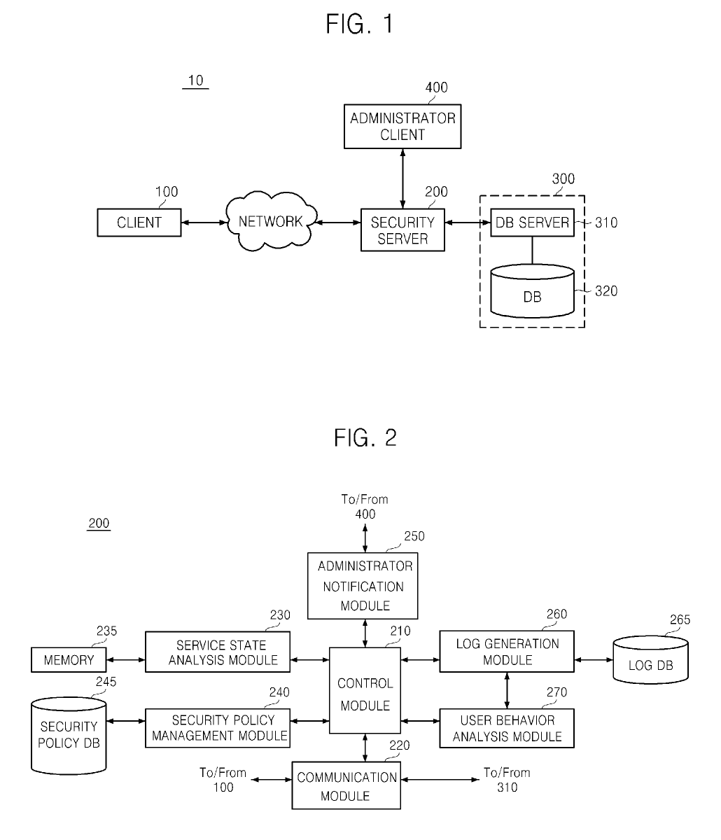

FIG. 1 is a block diagram which shows a schematic configuration of a database security system according to exemplary embodiments of the present inventive concepts. Referring to FIG. 1, a database security system 10 may include a client 100, a security server or a security device 200, a database system 300, and an administrator client 400. In addition, the database system 300 may include a database server 310 and a database 320.

The client 100 may request a service provided in the database system 300 and receive a service result by being connected to the security server 200 through a network (for example, a wired network or a wireless network). For example, the client 100 may transmit a request for a connection to the database server 310 and various commands or queries for an access to the database 320 to the security server 200.

When a user is connected to the security server 200, the client 100 may refer to the user, indicate a computer of the user, or may also refer to a program operating in the computer of the user.

When the client 100 indicates the computer of the user, the computer may be embodied as a personal computer (PC), or a portable electronic device or a mobile device. The portable electronic device may be embodied as a laptop computer, a mobile (or cellular) phone, a smart phone, a tablet PC, a personal digital assistant (PDA), an enterprise digital assistant (EDA), a digital still camera, a digital video camera, a portable multimedia player (PMP), a personal navigation device or portable navigation device (PND), a handheld game console, a mobile internet device (MID), a wearable device (or a wearable computer), an Internet of Things (IoT) device, an Internet of Everything (IoE) device, or an e-book.

Even if only one client 100 connected to the security server 200 through a network is shown in FIG. 1, but the database security system 10 may, of course, be constituted by a plurality of clients.

The security server 200 may perform security functions for all operations in which the client 100 accesses the database 320 on the basis of a situation analysis of the database system 300 and a behavior analysis of the client 100.

The security server 200 may change a security policy in accordance with a service state of the database system 300, and perform security on the database system 300 on the basis of a changed security policy.

According to exemplary embodiments, the security server 200 may classify the service state of the database system 300 into two or more states in accordance with a set condition, and set different security policies in respective states.

For example, the security server 200 may classify the service state of the database system 300 into a development state and an actual service state on the basis of a service start time. In addition, the security server 200 may classify the service state into a first service state to an n^{th} service state on the basis of a security level according to the amount or the importance of data accumulated in the database, or a usage situation such as the number of times of connection of the client 100.

For convenience of description in the following specification, in the following description, it is assumed that the service state is classified into a “development and test state” and an “actual service state,” but a technical concept of the present inventive concepts is not limited thereto as described above.

In a development and test state, the client 100 may be allowed to use all commands (or queries) related to an access to the database 320, but there may be a restriction on a use of some commands such as an entire data deletion or an entire data inquiry in the actual service state.

The security server 200 may request the administrator client 400 to confirm whether to execute a corresponding command if it is determined that a command transmitted from the client 100 does not satisfy a currently-applied security policy, and may transmit the command to the database server 310 or delete the command in accordance with a confirmation response from the administrator client 400.

The security server 200 may generate and store a log related to connection and access information of the client 100 to the database system 300, analyze a behavior pattern of the client 100 on the basis of the log, and determine whether a command transmitted from the client 100 matches the analyzed behavior pattern.

If it is determined that a command transmitted from the client 100 does not match the behavior pattern of the client 100, the security server 200 may transmit a result of the determination to the administrator client 400 to confirm whether to execute the command, or forcibly terminate the connection of the client 100 thereto.

The database system 300 may store and manage necessary data for providing a service in the database 320, execute an operation requested by the client 100 through the security server 200, and provide the client 100 with a result of the execution under control of the database server 310 equipped with a database management system (DBMS).

The database system 300 may be a relational database system, and may use a structured query language (SQL) as a standard language for interfacing with the client 100. The database system 300 includes a database server 310 and database 320, database server 310 manages the database 320 for storing and retrieving data to or from the database 320.

The administrator client 400 may be connected to the security server 200 to provide a plurality of security policies for the database system 300, and select a security policy to be applied in accordance with a degree of service progress of the database system 300 among the plurality of security policies.

The administrator client 400 may receive a confirmation request related to security policy violation of the client 100 from the security server 200, and transmit a response message to the confirmation request to the security server 200. The administrator client 400 may refer to an administrator, a computer of the administrator, or may also refer to a program operating in the computer of the administrator.

FIG. 2 is a block diagram which shows a specific configuration of the security server according to the exemplary embodiments of the present inventive concepts. Referring to FIGS. 1 and 2, the security server or the security device 200 may include a control module 210, a communication module 220, a service state analysis module 230, a security policy management module 240, an administrator notification module 250, a log generation module 260, and a user behavior analysis module 270. In addition, the security server 200 may include a memory 235 for data storage, a security policy database (DB) 245, and a log DB 265.

The control module 210 may control an overall operation of the security server 200 by controlling at least one of the communication module 220, the service state analysis module 230, the security policy management module 240, the administrator notification (or alarm) module 250, the log generation module 260, and the user behavior analysis module 270.

The control module 210 may determine whether a command received from the client 100 satisfies a currently-applied security policy. As a result of the determination, if the command does not satisfy the currently-applied security policy, the control module 210 may delete the command or transmit an indication signal indicating that the command violates the security policy to the administrator notification module 250.

The administrator notification module 250 may request the administrator client 400 to confirm whether to execute the command through various display means (for example, screen display, messenger, short message service (SMS), and mail and so on) according to an indication signal received from the control module 210.

The communication module 220 may receive a request for a connection to the database server 310 and a request, for example, a command or query, for an access to the database 320 from the client 100 to transmit the requests to the database server 310, and may receive responses to the requests from the database server 310 to transmit the responses to the client 100. Moreover, the communication module 220 may forcibly terminate a connection between the client 100 and the database server 310.

The service state analysis module 230 may determine a service progress state of the database system 300, for example, whether the database system 300 is currently in a development and test state or in an actual service state.

According to exemplary embodiments, information indicating the service progress state of the database system 300 may be stored in the memory 235, and the service state analysis module 230 may perform determination with reference to the memory 235.

The service progress state of the database system 300 may be set according to an indication signal provided from the administrator client 400. For example, an administrator may set a state flag stored in the memory 235 in the security server 200 as logic “0” or data “0” in the development and test state, and may set the state flag as logic “1” or data “1” in the actual service state.

The memory 235 may be embodied as a volatile memory such as a register, a dynamic random access memory (DRAM) or a static random access memory (SRAM), and/or a non-volatile memory such as a flash-based memory.

According to exemplary embodiments, the service progress state of the database system 300 may be determined on the basis of at least one of the amount of data stored in the database 320, log information on the database system 300, and a current request state for the database system 300.

For example, the service state analysis module 230 may determine that the database system 300 is currently in the actual service state when the amount of data stored in the database 320 exceeds a reference value. Moreover, the service state analysis module 230 may determine whether the database system 300 is currently in the actual service state by comparing the number of connections of the client 100 to the database server 310 and the number of accesses to the database system 300 with reference values.

That is, since the service state analysis module 230 may determine the service progress state of the database system 300 on the basis of the amount of data stored in the database 320, in addition to checking a state flag stored in the memory 235, it is possible to provide accurate information on the service progress state even when a state flag is changed due to hacking.

The security policy management module 240 may change a security policy for the database system 300 in accordance with a current service progress state of the database system 300 analyzed by the service state analysis module 230, and provide a changed security policy to the control module 210.

For example, when the database system 300 is in the development and test state, the security policy management module 240 may apply a first security policy to the database system 300, and when the database system 300 is in the actual service state, the security policy management module 240 may apply a second security policy to the database system 300.

The first security policy and the second security policy may be stored in the security policy DB 245, and may include different policies.

According to an exemplary embodiment, the second security policy, unlike the first security policy, may include a policy which inhibits the client 100 from using some commands among commands (or queries) related to an access to the database 320, and a policy which inhibits a user whose command does not match the behavior pattern of the user from accessing the database server 310.

The commands related to an access to the database 320 may include command languages such as a data manipulation language (DML) used to add (INSERT), change (UPDATE), or delete (DELETE) a new row to or from a record for data processing, a data definition language (DDL) used to generate (CREATE) and delete (DROP) tables or users for data definition, a data control language (DCL) used to generate a user and grant the user authority for data control, and a query used to acquire a value of the record for data inquiry.

In this case, the second security policy may inhibit a user from using commands related to a deletion of data stored in the database 320 (for example, DELETE, DROP, and the like) among the commands Moreover, the second security policy may inhibit a user from using commands requesting a deletion, change, or inquiry of data exceeding a reference data amount.

The log generation module 260 may monitor a connection or an access of the client 100 to the database system 300, generate a log related to information acquired through monitoring, store and manage the log in the log DB 265.

The log DB 265 may include at least one of connection IP information, user ID information, terminal information, application information, time information, query information, and command information.

The log generation module 260 may search for information on a connection IP, a connection time zone, a terminal name, and a requested command of a user using a specific ID in the log DB 265, and provide the searched pieces of information to the user behavior analysis module 270.

The user behavior analysis module 270 may analyze a behavior pattern of the client 100 and provide the analyzed behavior pattern of the client 100 to the control module 210 on the basis of log information on the client 100 provided from the log generation module 260.

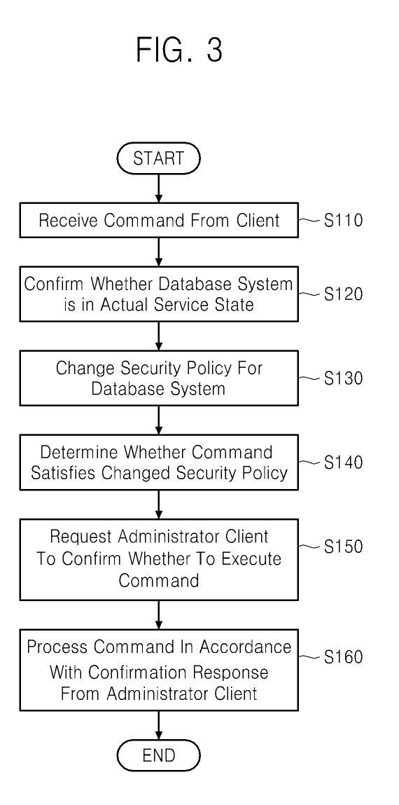

FIG. 3 is a flowchart which shows an operating method of a security server according to exemplary embodiments of the present inventive concepts. Referring to FIGS. 1 to 3, the security server 200 may receive commands related to the database 320 from a client 100 connected thereto through a network (S110).

The security server 200 may perform a series of security procedures of analyzing a situation of the database system 300 before transmitting the command to the database server 310, and determining whether to execute the command according to a result of the analysis.

First, the security server 200 may confirm a service state of the database system 300 (S120). For example, the service state may be classified into a development state and an actual service state.

For the confirmation in step S120, the security server 200 may refer to a state flag stored in a security server. The state flag indicates a state in accordance with a degree of the service progress of the database system 300, and may be set as logic “0” in the development state or may be set to logic “1” in the actual service state.

Moreover, the security server 200 may refer to the amount of data stored in the database 320, log information on the database system 300, and/or a request state for a database system for the confirmation in step S120.

As a result of the confirmation in step S120, when it is confirmed that the database system 300 is changed from the development state to the actual service state, the security server 200 may change a security policy for the database system 300 (S130).

That is, a security policy in the actual service state is different from a security policy in the development state, and it is possible to inhibit the client 100 from using some commands available in the development state among the commands related to the database 320. Here, the some commands may include commands for deleting or releasing a large amount of data stored in the database 320 such as an entire data deletion command or an entire data inquiry command.

After a security policy for the database system 300 is changed in step S130, the security server 200 may determine whether the command received from the client 100 satisfies the changed security policy (S140).

As a result of the determination in step S140, when the command received from the client 100 does not satisfy the change security policy, the security server 200 may request the administrator client 400 to confirm whether to execute the command (S150).

A confirmation request in step S150 may be performed through a screen display, a messenger, SMS, or a mail, and the security server 200 may receive a response to the confirmation request from the administrator client 400 and process the command (S160).

For example, the security server 200 may transmit the command to the database server 310 in accordance with an executable response of the command, or delete the command and transmit a corresponding message to the client 100 in accordance with a non-executable response of the command

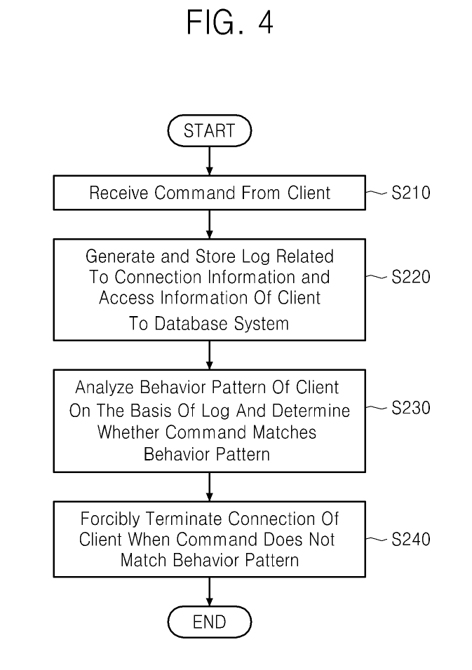

FIG. 4 is a flowchart which shows the operating method of a security server according to exemplary embodiments of the present inventive concepts. Referring to FIGS. 1, 2, and 4, the security server 200 may receive a command related to the database 320 from a client 100 connected thereto through a network (S210).

The security server 200 may analyze a behavior of a user before transmitting the command to the database server 310, and accordingly perform a series of security procedures for determining whether to execute the command. First, the security server 200 may monitor a connection and an access of the client 100 to the database system 300, generate and store a log of information acquired through the monitoring (S220).

The log may include at least one of connection IP information, user ID information, terminal information, application information, time information, query information, and command information.

The security server 200 may analyze a behavior pattern of the client 100 on the basis of the log generated in step S230, and determine whether a command received from the client 100 matches the analyzed behavior pattern of the client 100 (S230).

As a result of the determination in step S230, when there is a slight variation (for example, when a user performs an access through another IP or terminal, and transmits a command) at the time of comparing the command with the behavior pattern, the security server 200 may transmit only a corresponding notification message to the administrator client 400.

In addition, as a result of the determination in step S230, when there is a significant change (for example, when a user performs an access only during working hours for one year and suddenly continues to access and transmit a command at midnight, when a user transmits a command requesting a transfer of all money in his bank account, or when a user transmits a command requesting batch deletion of all data) at the time of comparing the command with the behavior pattern, the security server 200 may delete the command and forcibly block the connection between the client 100 and the database server 310 (S240).

### INDUSTRIAL APPLICABILITY

The present inventive concepts may be used for a database security apparatus and an operating method of a security apparatus for security management of a database system.

What is claimed is:

1. An operating method of a security apparatus for security management of a database system comprising:
receiving a command related to a database managed in the database system from a client;
confirming a service state of the database system;
changing a security policy for the database system according to a result of the confirmation;
determining whether the command transmitted from the client satisfies the changed security policy; and
transmitting a request for confirming whether to execute the command to an administrator client according to a result of the determination.

2. The operating method of a security apparatus according to claim 1,
wherein the service state is classified into at least two states in accordance with a set condition, and different security policies are applied in respective states.

3. The operating method of a security apparatus according to claim 1,
wherein the confirming confirms the service state with reference to a state flag indicating the service state of the database system.

4. The operating method of a security apparatus according to claim 1,
wherein the confirming confirms the service state on the basis of cumulative data information stored in the database, log information on the database, and a request state for the database system.

5. The operating method of a security apparatus according to claim 1,
wherein the changing changes the security policy such that the client cannot use some commands among commands related to the database.

6. The operating method of a security apparatus according to claim 1,
wherein, when the command requests deletion, change, or inquiry of data exceeding a reference data amount, the determining determines that the command does not satisfy the changed security policy.

7. The operating method of a security apparatus according to claim 1, further comprising:
monitoring a connection and an access of the client to the database system;
generating and storing a log of information acquired through the monitoring;
analyzing a behavior pattern of the client on the basis of the log; and
determining whether the command transmitted from the client matches the behavior pattern of the client.

8. The operating method of a security apparatus according to claim 7,
wherein the log includes at least one of connection IP information, user ID information, terminal information, application information, time information, query information, and command information.

9. The operating method of a security apparatus according to claim 7, further comprising:
forcibly terminating the connection of the client when the command does not match the behavior pattern of the client.

10. A database security apparatus comprising:
a communication module for receiving commands related to a database managed in a database system from a client;
a service state analysis module for confirming a service state of the database system;
a security policy management module for changing a security policy for the database system according to a result of the confirmation;
a control module for determining whether the commands transmitted from the client satisfies the change security policy; and
an administrator notification module for transmitting a confirmation request for confirming whether to execute the commands to an administrator client according to a result of the determination.

11. The database security apparatus according to claim 10, further comprising:
a log generation module for monitoring a connection and an access of the client to the database system, and generating and storing a log of information acquired through the monitoring; and
a behavior analysis module for analyzing a behavior pattern of the client on the basis of the log,
wherein the control module determines whether the commands transmitted from the client match the behavior pattern of the client.
